(19) United States
(12) Patent Application Publication
(10) Pub. No.: US 2012/0275767 A1
(43) Pub. Date: Nov. 1, 2012

(54) CONTENT CONTROL DEVICE AND CONTENT CONTROL METHOD

(75) Inventors: Nobuaki Sasao, Kawasaki-shi (JP); Koji Ishii, Zushi-shi (JP)

(73) Assignee: NTT DOCOMO, INC., Tokyo (JP)

(21) Appl. No.: 13/504,751

(22) PCT Filed: Sep. 1, 2010
(86) PCT No.: PCT/JP2010/064926

§ 371 Date: Jul. 10, 2012

(30) Foreign Application Priority Data
Oct. 28, 2009 (JP) 2009-247864

(51) Int. Cl. H04N 9/80

(52) U.S. Cl. 386/259; 386/E05.004

(57) ABSTRACT

A content control device (1) for performing playback control and protection of a pay content includes a license management unit (69) that executes an accounting process for a user after a mobile terminal (10) completes reception of the pay content, an accounting completion determination unit (70) that determines whether accounting has completed, a S1 encryption unit (65) that encrypts the pay content received by the mobile terminal (10) and stores it as a first encrypted content, and a S2 encryption unit (68) that, when accounting on the pay content has completed, decrypts the first encrypted content, encrypts the pay content by a method different from the S1 encryption unit (65), and stores it as a second encrypted content, and when a request for playback of the pay content is made, the second encrypted content is decrypted and provided to the mobile terminal (10).

### TECHNICAL FIELD

The present invention relates to a content control device and a content control method.

### BACKGROUND ART

A broadcast receiving terminal that receives and records a pay broadcast program (content) and displays the recorded content according to results of authentication and accounting is known (for example, see Patent Literature 1). The broadcast receiving terminal disclosed in Patent Literature 1 is configured to be able to communicate with an accounting server that manages accounting, and displays the content according to results of authentication and accounting in the accounting server.

### CITATION LIST

### Patent Literature

PTL 1: Japanese Patent No. 4308958

### SUMMARY OF INVENTION

### Technical Problem

With the diversification of communications, there would be cases where the above-described content would be broadcasted to a portable receiving terminal such as a mobile terminal. In the case where the receiving terminal moves, there is a possibility that not all data of the purchased content can be received, for example. One possible approach is to perform an accounting process after the receiving terminal has received all data. In this case, however, there is a possibility that the received content is played back before accounting is done or the received content is copied into another receiving terminal and played back. Thus, one approach to avoid this is to encrypt the received content in association with receiving terminal information or the like and then decrypt and play it back after accounting is done. In this case, however, because the content cannot be played back in a receiving terminal different from that receiving terminal, there is a possibility that it fails to address the changing of the receiving terminal or the like.

The present invention has been accomplished in view of the foregoing, and an object of the invention is thus to provide a content control device and a content control method capable of appropriately performing playback and protection of the pay content before and after the completion of accounting.

### Solution to Problem

Specifically, a content control device according to the present invention is a content control device connected to a receiving terminal that receives and plays back a content and performing playback control and protection of a pay content, which includes an accounting execution unit that executes an accounting process for a user to view the pay content after the receiving terminal completes reception of the pay content, an accounting completion determination unit that determines whether accounting on the pay content has completed, a first protection unit that encrypts the pay content received by the receiving terminal and stores the encrypted pay content as a first encrypted content, and a second protection unit that, when the accounting completion determination unit determines that accounting on the pay content has completed, decrypts the first encrypted content, encrypts the pay content obtained by decryption by a method different from the first protection unit, and stores the encrypted pay content as a second encrypted content, wherein, when a request for playback of the pay content is made, the second encrypted content is decrypted and provided to the receiving terminal.

In the content control device according to the present invention, the accounting process for a user to view the pay content is executed after the reception of the pay content has completed. It is thus possible to prevent accounting from being performed on the content for which not all data is received, for example, thus enabling execution of an appropriate accounting process. Further, the pay content is encrypted and recorded as the first encrypted content by the first protection unit. Because the received pay content is encrypted in this manner, the received pay content can be encrypted in such a way that a purchaser can decrypt it only in the receiving terminal, for example. It is thus possible to prevent the received pay content from being played back before accounting is done or from being copied to another receiving terminal and played back. Furthermore, when it is determined by the accounting completion determination unit that accounting on the pay content has completed, the first encrypted content is decrypted by the second protection unit, and the pay content obtained by the decryption is encrypted by a method different from that of the first protection unit and recoded as a second encrypted content. In this manner, because the received pay content is encrypted again by another method after accounting is done, the received pay content can be encrypted in such a way that only a purchaser can decrypt it, for example. The purchaser can thereby play back the pay content, and it is thus possible to address the changing of the receiving terminal or the like.

It is preferred that the first protection unit performs encryption using an encryption key containing a random value and information specific to the user, and stores the random value into a storage unit of the receiving terminal, and the second protection unit performs decryption by acquiring the random value in reference to the storage unit and generating a decryption key based on the acquired random value and the information specific to the user.

In this configuration, the received content can be encrypted in such a way that a purchaser can decrypt it only in the receiving terminal. It is thus possible to prevent the received pay content from being played back before accounting is done or from being copied to another receiving terminal and played back. It is thereby possible to prevent illegal leakage of the pay content.

Alternatively, the first protection unit may perform encryption using an encryption key containing information specific to the receiving terminal and information specific to the user, and the second protection unit may perform decryption by generating a decryption key based on the information specific to the receiving terminal and the information specific to the user. In this configuration also, the received content can be encrypted in such a way that a purchaser can decrypt it only in the receiving terminal.

Further, it is preferred that the second protection unit encrypts and decrypts the pay content using the information specific to the user as an encryption key and a decryption key. In this configuration, the received content can be encrypted in such a way that only a purchaser can decrypt it. It is thus possible to address the changing of the receiving terminal or the like.

Furthermore, a content control method according to the present invention is a content control method executed by a content control device connected to a receiving terminal that receives and plays back a content and including an accounting execution unit that executes an accounting process for a user to view a pay content, an accounting completion determination unit that determines whether accounting on the pay content has completed, a first protection unit that encrypts the pay content and stores the encrypted pay content as a first encrypted content, and a second protection unit that decrypts the first encrypted content, encrypts the pay content obtained by decryption by a method different from the first protection unit, and stores the encrypted pay content as a second encrypted content, the method including an accounting execution step of executing an accounting process for a user to view the pay content by the accounting execution unit after the receiving terminal completes reception of the pay content, an accounting completion determination step of determining whether accounting on the pay content has completed by the accounting completion determination unit, a first protection step of, when the receiving terminal has received the pay content, acquiring the pay content from the receiving terminal, encrypting the pay content, and storing the encrypted pay content as a first encrypted content by the first protection unit, and a second protection step of, when the accounting completion determination step determines that accounting on the pay content has completed, decrypting the first encrypted content, encrypting the pay content obtained by decryption by a method different from the first protection step, and storing the encrypted pay content as a second encrypted content by the second protection unit, wherein, when a request for playback of the pay content is made, the second encrypted content is decrypted and provided to the receiving terminal.

In the content control method according to the present invention, the same advantageous effects as the content control device described above can be obtained.

### Advantageous Effects of Invention

According to the present invention, it is possible to appropriately perform playback and protection of the pay content before and after the completion of accounting.

### BRIEF DESCRIPTION OF DRAWINGS

FIG. 1 is a schematic configuration diagram of a broadcast system provided with a receiving terminal that includes a content control device according to an embodiment.

FIG. 2 is a hardware configuration diagram of the receiving terminal that includes the content control device according to the embodiment.

FIG. 3 is a block diagram showing functions of the receiving terminal that includes the content control device according to the embodiment.

FIG. 4 is a flowchart showing a content storing operation of the receiving terminal that includes the content control device according to the embodiment.

FIG. 5 is a flowchart showing a content playback operation of the receiving terminal that includes the content control device according to the embodiment.

### DESCRIPTION OF EMBODIMENTS

An embodiment of a content control device and method according to the present invention will be described hereinafter in detail with reference to the appended drawings. It is noted that in the description of the drawings the same elements will be denoted by the same reference symbols and redundant description will be omitted.

The content control device and method according to the embodiment are suitably used for broadcast or delivery of pay contents to a receiving terminal such as a mobile terminal in analog and digital broadcast services or radio communication services, for example.

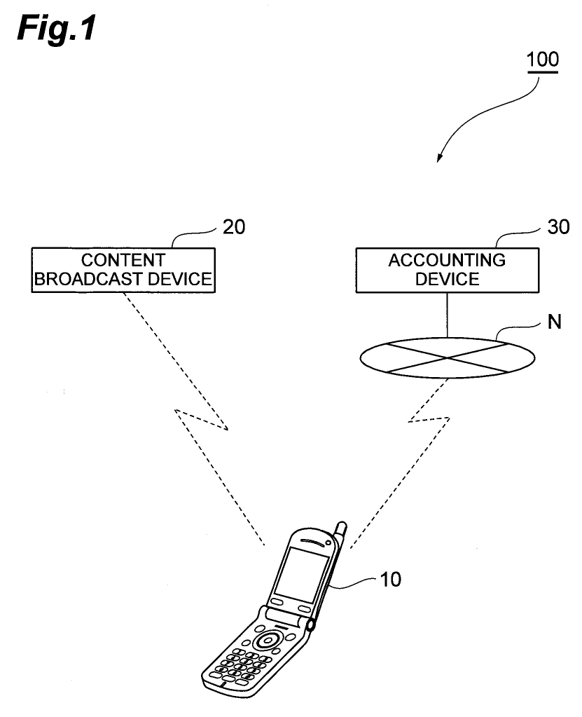

The overview of a broadcast system provided with a mobile terminal that includes the content control device according to the embodiment is described firstly with reference to FIG. 1. FIG. 1 is a schematic configuration diagram of a broadcast system 100.

As shown in FIG. 1, the broadcast system 100 includes a content broadcast device 20 that broadcasts a content at a predetermined frequency, a mobile terminal 10 that functions as a receiver to receive the content, and an accounting device 30 that is connected with the mobile terminal 10 through a communication network N. As the communication network N, a mobile communication network, a wireless LAN network or the like may be used.

The content broadcast device 20 is configured to be able to broadcast pay contents for which accounting is required, for example. The content broadcast device 20 has a function of scrambling the pay content with a scramble key Ks and providing the scrambled pay content, the scramble key Ks and other information required for viewing by multiplexing, for example. The accounting device 30 has a function of calculating a charge of the pay content to be paid by a user based on information about accounting transmitted from the mobile terminal and performing accounting. Further, the accounting device 30 has a function of transmitting a notification about the completion of accounting to the mobile terminal 10 when accounting is done. As the accounting device 30, an information processing device that includes a communication unit, an operation unit, a storage unit and an input/output unit may be used.

The mobile terminal 10 is a portable terminal that is carried by a user, and it is a terminal having a function of receiving a broadcast with a predetermined frequency and a wireless data communication function, for example. The mobile terminal 10 has a function of accumulating the contents received by broadcasting and playing them back. As the mobile terminal 10, a mobile phone, a PHS, a PDA (Personal Digital Assistant) with a wireless communication card or the like may be used.

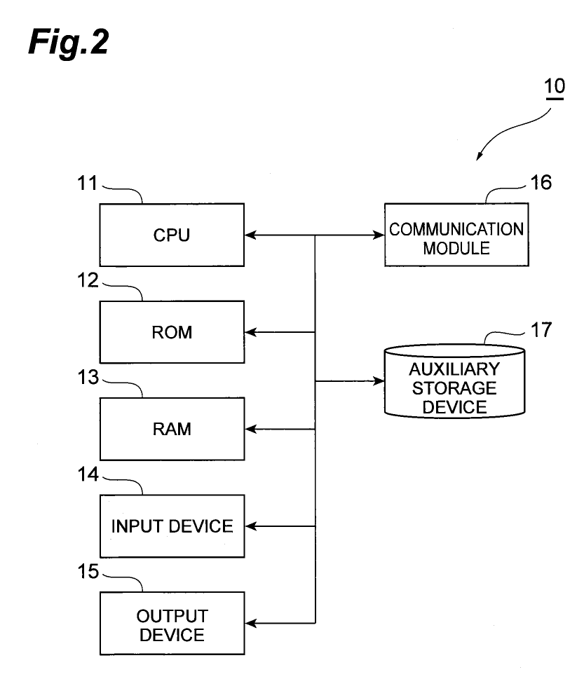

The hardware configuration of the mobile terminal 10 is described hereinbelow. FIG. 2 is a hardware configuration diagram of the mobile terminal 10. As shown in FIG. 2, the mobile terminal 10 is physically configured as a typical computer system that includes a CPU 11, a main storage device such as a ROM 12 and a RAM 13, an input device 14, an output device 15 such as a display, a communication module 16 for transmitting and receiving data to and from the accounting device 30, an auxiliary storage device 17 such as a hard disk and the like. The functions of the mobile terminal 10 described later are implemented by loading given computer software onto hardware such as the CPU 11, the ROM 12 or the RAM 13, making the input device 14, the output device 15 and the communication module 16 operate under control of the CPU 11, and performing reading and writing of data in the ROM 12, the RAM 13 or the auxiliary storage device 17.

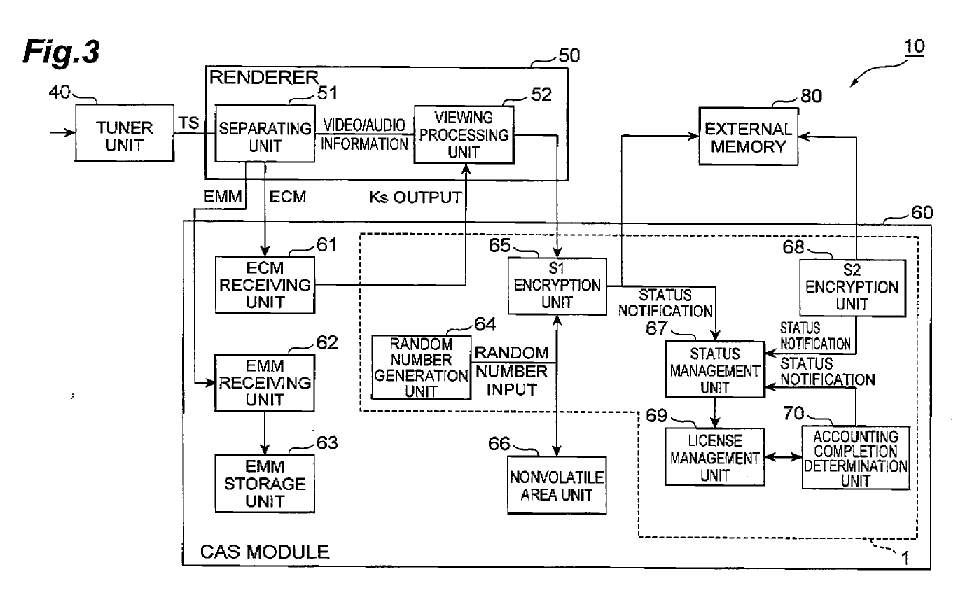

FIG. 3 is a block diagram showing functions of the mobile terminal 10. As shown in FIG. 3, the mobile terminal 10 includes a tuner unit 40, a renderer 50, a CAS (Conditional Access System) module 60, and an external memory 80.

The tuner unit 40 is connected to an antenna that receives a pay content broadcast and outputs TS (Transport Stream) of the received pay content to the renderer 50. TS is a data stream in which video/audio information, information required for viewing and the like are multiplexed.

The renderer 50 includes a separating unit 51 and a viewing processing unit 52. The separating unit 51 separates the TS that is output from the tuner unit 40 into video/audio information and information to be used for performing processing required for viewing in the CAS module 60. The information to be used for performing processing required for viewing includes ECM (Entitlement Control Message) and EMM (Entitlement Management Message). The renderer 50 outputs the video/audio information to the viewing processing unit 52 and outputs the ECM and EMM to the CAS module 60.

The viewing processing unit 52 decodes the video/audio information that is output from the separating unit 51 and descrambles the information using a scramble key Ks, thereby making the content in a viewable form. The scramble key Ks used is output from the CAS module 60. Further, the content that has been converted into a viewable form is output to the CAS module 60.

The CAS module 60 is connected to the renderer 50, and it includes an ECM receiving unit 61, an EMM receiving unit 62, an EMM storage unit 63, and a content control device 1.

The ECM receiving unit 61 receives the ECM that is output from the renderer 50, decrypts it and thereby acquires the scramble key Ks. The ECM receiving unit 61 then outputs the scramble key Ks to the viewing processing unit 52.

The EMM receiving unit 62 receives the EMM that is output from the renderer 50, decrypts it and thereby acquires contract information and key information for decryption. The EMM receiving unit 62 then stores the decrypted EMM into the EMM storage unit 63. Note that this is the case where the EMM is acquired through broadcasting, and, when the EMM is acquired through communication, it is acquired from a radio unit such as the communication module 16.

The content control device 1 has a function of performing playback control and protection of pay contents. The content control device 1 includes a random number generation unit 64, a S1 encryption unit (first protection unit) 65, a nonvolatile area unit (storage unit) 66, a status management unit 67, a S2 encryption unit (second protection unit) 68, a license management unit (accounting execution unit) 69, and an accounting completion determination unit 70.

The random number generation unit 64 has a function of generating a random number (random value). The random number generation unit 64 outputs the generated random number to the S1 encryption unit 65.

The S1 encryption unit 65 has a function of encrypting (S1-encrypting) the pay content that is output from the viewing processing unit 52 of the renderer 50. The S1 encryption unit 65 has a function of performing encryption in such a way to allow decryption only by the mobile terminal 10 and a purchaser of the pay content. Specifically, the S1 encryption unit 65 has a function of performing encryption using the random number (random value) that is output from the random number generation unit 64 and UIM (User Identity Module)-specific information as an encryption key. The UIM-specific information is information specific to UIM, which is an IC card on which contractor information such as a telephone number is recoded, and it is information for uniquely identifying a user. The S1 encryption unit 65 stores the random number used for encryption into the nonvolatile area unit 66 and stores the encrypted pay content (S1 encrypted content) into the external memory 80. Further, the S1 encryption unit 65 notifies the status management unit 67 that the pay content has been encrypted.

The S2 encryption unit 68 has a function of decrypting the S1 encrypted content stored in the external memory 80 using the random number recorded on the nonvolatile area unit 66 and the UIM-specific information as a decryption key. The S2 encryption unit 68 further has a function of performing encryption by an encryption method different from the encryption method of the S1 encryption unit 65. For example, the S2 encryption unit 68 has a function of performing encryption in such a way to allow playback in the mobile terminal 10 and another terminal changed from the mobile terminal 10 and also allow playback only by a purchaser. Specifically, the S2 encryption unit 68 has a function of encrypting (S2-encrypting) the pay content obtained by decryption using the UIM-specific information as an encryption key. The S2 encryption unit 68 stores the encrypted pay content (S2 encrypted content) into the external memory 80. Further, the S2 encryption unit 68 notifies the status management unit 67 that the pay content has been encrypted. Furthermore, the S2 encryption unit 68 has a function of decrypting the S2 encrypted content using the UIM-specific information as a decryption key upon request for playback.

The license management unit 69 has a function of performing license management of pay contents. For example, after accepting the viewing of a pay content from a user, the license management unit 69 checks the reception of the pay content. When the completion of reception of the pay content is confirmed, the license management unit 69 notifies the accounting device 30 that the reception has completed and causes the accounting device 30 to execute an accounting process. Thus, the reception completion notification process of the license management unit 69 serves as the accounting process on the mobile terminal 10 side. The accounting for the pay content is thereby executed after receiving the pay content. Further, the license management unit 69 notifies the status management unit 67 that the reception of the pay content has completed. Then, when a notification for the completion of accounting is received from the accounting device 30, the license management unit 69 stores information that the user is a user having a license (license purchase information) into the nonvolatile area unit 66, for example.

The accounting completion determination unit 70 has a function of determining that accounting for the pay content has completed. For example, the accounting completion determination unit 70 determines that accounting has completed when the license management unit 69 receives the accounting completion notification from the accounting device 30. Then, the accounting completion determination unit 70 notifies the status management unit 67 that accounting has completed.

The status management unit 67 has a function of managing the status related to pay contents based on accounting status and encryption status. For example, the status management unit 67 has a function of managing the status related to pay contents based on notifications from the S1 encryption unit 65, the S2 encryption unit 68, the license management unit 69 and the accounting completion determination unit 70. The status management unit 67 has a function of managing three types of status: a state where reception of a pay content has completed and accounting for the pay content is not done (Status S1), a state where reception of a pay content has completed and accounting for the pay content is done (Status S2), and a state where encryption has completed by the S2 encryption unit 68 (Status S3), for example. The content control device 1 controls the operation to play back the pay content depending on the status.

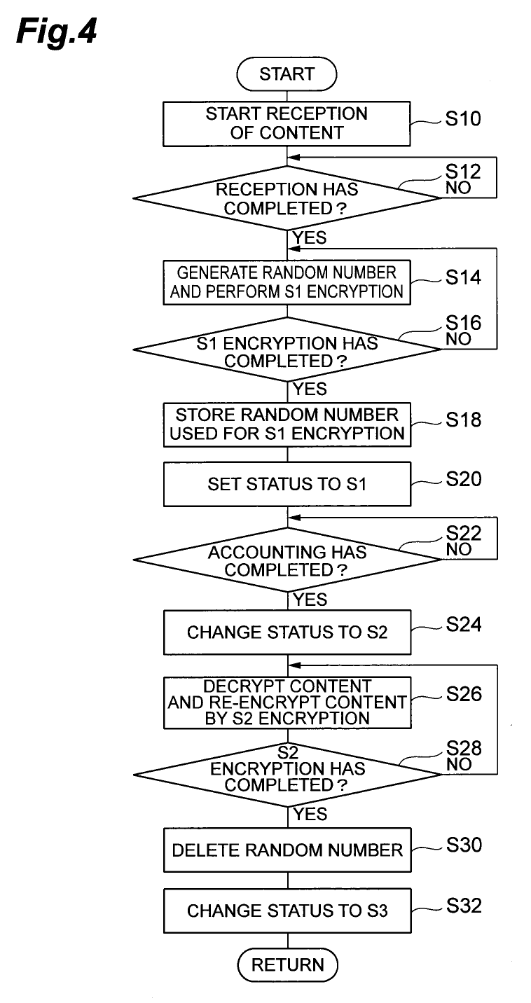

The operation of the receiving terminal that includes the content control device 1 according to the embodiment is described hereinbelow. FIG. 4 is a flowchart showing the operation of the content control device 1 at the time of storing contents. The control process shown in FIG. 4 starts at the timing when a user makes a reservation for acquisition of a pay content, for example.

First, as shown in FIG. 4, the tuner unit 40 starts the reception of the pay content (Step S10). After that, the license management unit 69 determines whether the reception of the pay content has completed or not (Step S12). The license management unit 69 repeats the processing of Step S12 until it determines that the reception of the pay content has completed. Note that, when the completion of reception of the pay content cannot be determined even after the lapse of a specified period, the process shown in FIG. 4 may end.

When it is determined that the reception of the pay content has completed, the license management unit 69 notifies the completion of reception of the pay content to the status management unit 67. Then, the random number generation unit 64 generates a random number and outputs it to the S1 encryption unit 65. Then, the S1 encryption unit 65 starts encryption of the received pay content using the random number and the UIM-specific information as an encryption key (Step S14).

After that, the S1 encryption unit 65 determines whether the S1 encryption has completed or not (Step S16). The 51 encryption unit 65 repeats the processing of Step S14 until it determines that the S1 encryption has completed. When it is determined that the S1 encryption has completed, the S1 encryption unit 65 stores the random number used for the S1 encryption into the nonvolatile area unit 66 (Step S18). Then, the S1 encryption unit 65 notifies the completion of the S1 encryption to the status management unit 67 and stores the S1 encrypted content into the external memory 80.

Receiving the completion of the S1 encryption, the status management unit 67 sets the status of the mobile terminal 10 to Status S1 (Step S20). After that, the accounting completion determination unit 70 determines whether the accounting of the pay content has completed or not (Step S22). The accounting completion determination unit 70 repeats the determination until it determines that the accounting of the pay content has completed. Note that the accounting process on the terminal side is executed after the 51 encryption has completed in Step S16 and when a user expresses an intention to pay a charge for the content received by the mobile terminal 10 by means of the terminal operation or the like, for example.

When the accounting completion determination unit 70 determines the completion of accounting of the pay content, the accounting completion determination unit 70 notifies the completion of accounting to the status management unit 67. Receiving the completion of accounting, the status management unit 67 changes the status of the mobile terminal 10 from Status S1 to Status S2 (Step S24).

After that, the S2 encryption unit 68 starts the process of decrypting the S1 encrypted content using the random number and the UIM-specific information as a decryption key and further encrypting the pay content obtained by decryption using the UIM-specific information as an encryption key in reference to the random number stored in the nonvolatile area unit 66 and the UIM-specific information stored in the UIM card (Step S26).

After that, the S2 encryption unit 68 determines whether the S2 encryption has completed or not (Step S28). The S2 encryption unit 68 repeats the processing of Step S26 until it determines that the S2 encryption has completed. When it is determined that the S2 encryption has completed, the S2 encryption unit 68 deletes the random number used for the S1 encryption from the nonvolatile area unit 66 (Step S30). Then, the S2 encryption unit 68 notifies the completion of the S2 encryption to the status management unit 67 and stores the S2 encrypted content into the external memory 80. Receiving the completion of the S2 encryption, the status management unit 67 changes the status of the mobile terminal 10 from Status S2 to Status S3 (Step S32). After Step S32, the control process shown in FIG. 4 ends.

By executing the control process of FIG. 4 described above, in the state where reception of the pay content has completed and accounting is not done, the pay content is encrypted using the random number generated in the mobile terminal 10 that has received the pay content and the UIM-specific information of a user who is using the mobile terminal 10. Therefore, the pay content that is stored in the state where accounting is not done can be decrypted only by the mobile terminal 10 that has received the pay content and a user who is using the mobile terminal 10. Therefore, decryption in a mobile terminal different from the mobile terminal 10 that has received the pay content or decryption by means of insertion of UIM of a person different from the purchaser of the mobile terminal 10 can be restricted. It is thus possible to prevent illegal leakage of the pay content.

Further, by executing the control process of FIG. 4 described above, the encrypted pay content is encrypted again, triggered by accounting, using the UIM-specific information of a user who is using the mobile terminal 10 that has received the pay content. Therefore, in the state where accounting is done, the stored pay content can be decrypted only by a user who is a purchaser of the pay content, and therefore decryption using the UIM-specific information of a person different from the purchaser can be restricted. Further, because the received pay content is encrypted using the UIM-specific information of the purchaser, the purchaser can access the pay content even after changing the mobile terminal into another mobile terminal or the like.

Furthermore, by using the different encryption methods before and after the completion of accounting, the license purchase information is reserved in the mobile terminal 10 that is used at the time of purchase, license management can be limited to the nonvolatile area unit 66 of the mobile terminal 10. It is thus possible to prevent leakage of the license.

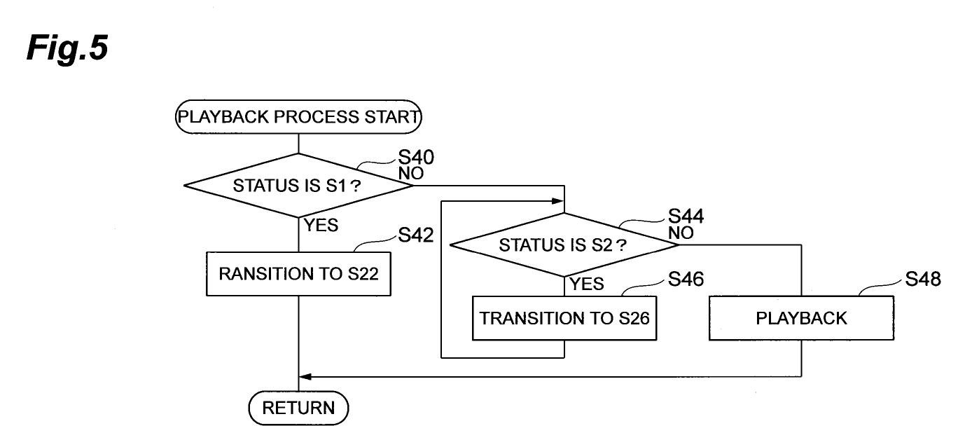

The playback operation of the pay content in the receiving terminal that includes the content control device 1 according to the embodiment is described hereinafter. FIG. 5 is a flowchart showing the content playback operation of the content control device 1. The control process shown in FIG. 5 starts at the timing when a request for playback of a pay content is made by an operation of a user, for example, and it is executed repeatedly at certain intervals. It is assumed that the status is set to any of S1 to S3 before the process, and the process does not start otherwise.

As shown in FIG. 5, when a playback operation of the pay content by a user is performed, the status management unit 67 determines whether the current status is Status S1 or not (Step S40).

When the status management unit 67 determines that the current status is Status S1, the process transitions to the accounting completion determination process shown in Step S22 of FIG. 4 (Step S42). Then, the control process shown in FIG. 5 ends. On the other hand, when the status management unit 67 determines that the current status is not Status S1, it determines whether the current status is Status S2 or not (Step S44).

When the status management unit 67 determines that the current status is Status S2, the process transitions to the encryption process shown in Step S26 of FIG. 4 (Step S46). Then, the process of Step S44 is executed repeatedly until the current status changes from Status S2 to Status S3. On the other hand, when the status management unit 67 determines that the current status is not Status S2, that is, when the status management unit 67 determines that the current status is Status S3, the S2 encryption unit 68 decrypts the S2 encrypted content to enable playback of the pay content. The pay content is thereby played back by the renderer 50 (Step S44). When Step S44 ends, the control process shown in FIG. 5 ends.

The control process shown in FIG. 5 thereby ends. By executing the control process shown in FIG. 5, it is possible to restrict the playback of the pay content before accounting.

As described above, in the content control device 1 according to the embodiment and the content control method by the content control device 1, the accounting process for a user to view the pay content is executed after the completion of reception of the pay content is determined by the license management unit 69. It is thus possible to prevent accounting from being performed on the content for which not all data is received, for example, thus enabling execution of an appropriate accounting process. Further, the pay content is encrypted and recorded as the S1 encrypted content by the S1 encryption unit 65. Because the received pay content is encrypted in this manner, the received pay content can be encrypted in such a way that a purchaser can decrypt it only in the mobile terminal 10, for example. It is thus possible to prevent the received pay content from being played back before accounting is done or from being copied to another mobile terminal 10 and played back. Furthermore, when it is determined by the accounting completion determination unit 70 that accounting for the pay content has completed, the first encrypted content is decrypted by the S2 encryption unit 68, and the pay content obtained by the decryption is encrypted by a method different from that of the S1 encryption unit 65 and recoded as a second encrypted content. In this manner, because the received pay content is encrypted again by another method after accounting is done, the received pay content can be encrypted in such a way that only a purchaser can decrypt it, for example. The purchaser can thereby play back the pay content, and it is thus possible to address the changing of the mobile terminal 10 or the like.

Further, in the content control device 1 according to the embodiment and the content control method by the content control device 1, the S1 encryption unit 65 performs encryption using the random number and the UM-specific information as an encryption key and records the random value into the nonvolatile area unit 66 of the mobile terminal 10, and the S2 encryption unit 68 acquires the random number by referring to the nonvolatile area unit 66, generates a decryption key based on the acquired random number and the UIM-specific information and performs decryption, and therefore the received content can be encrypted in such a way that a purchaser can decrypt it only in the mobile terminal 10. It is thus possible to prevent the received pay content from being played back before accounting is done or from being copied to another mobile terminal 10 and played back. It is thereby possible to prevent illegal leakage of the pay content.

Furthermore, in the content control device 1 according to the embodiment and the content control method by the content control device 1, the S2 encryption unit 68 encrypts the pay content using the UM-specific information as an encryption key, and therefore the received pay content can be encrypted in such a way that only a purchaser can decrypt it. The purchaser can thereby play back the pay content, and it is thus possible to address the changing of the mobile terminal 10 or the like.

It should noted that the above-described embodiment is an example of the content control device and the content control method according to the present invention. The content control device and the content control method according to the present invention are not limited to the content control device and the content control method according to the embodiment, and the content control device and the content control method according to the embodiment may be varied or applied in many ways without departing from the scope of the appended claims.

For example, although the content broadcast device 20 and the accounting device 30 are described as being separate devices in the above-described embodiment, they may be the same device. Further, although the accounting process of the mobile terminal 10 is described as being a process of transmitting the pay content reception completion notification to the accounting device 30, it is not limited thereto as long as accounting for the user is executed after the mobile terminal 10 receives the pay content.

Furthermore, although the example in which the S1 encryption unit 65 performs S1 encryption by generating an encryption key based on the random number and the UIM-specific information and the S2 encryption unit 68 performs decryption by generating a decryption key based on the random number and the UIM-specific information is described in the above-described embodiment, information specific to the mobile terminal 10 may be used instead of the random number. As the information specific to the mobile terminal 10, a terminal serial number may be used, for example. By using the information specific to the mobile terminal 10 instead of the random number, the received content can be encrypted in such a way that a purchaser can decrypt it only in the receiving terminal, just like the case of performing encryption using the random number. Further, using the information specific to the mobile terminal 10 instead of the random number eliminates the need to include the random number generation unit 64 and further allows omission of the process that the S1 encryption unit 65 stores the random number used for encryption into the nonvolatile area unit 66. It is thus possible to reduce the processing load and the storage capacity compared to the case of using the random number.

### REFERENCE SIGNS LIST

1 . . . Content control device, 10 . . . Mobile terminal (Receiving terminal), 20 . . . Content broadcast device, 30 . . . Accounting device, 65 . . . S1 encryption unit (First protection unit), 66 . . . Nonvolatile area unit (Storage unit), 67 . . . Status management unit, 68 . . . S2 encryption unit (Second protection unit), 69 . . . License management unit (Accounting execution unit), 70 . . . Accounting completion determination unit, 100 . . . Broadcast system

1. A content control device connected to a receiving terminal that receives and plays back a content and performing playback control and protection of a pay content, comprising:
an accounting execution unit that executes an accounting process for a user to view the pay content after the receiving terminal completes reception of the pay content;
an accounting completion determination unit that determines whether accounting on the pay content has completed;
a first protection unit that encrypts the pay content received by the receiving terminal and stores the encrypted pay content as a first encrypted content; and
a second protection unit that, when the accounting completion determination unit determines that accounting on the pay content has completed, decrypts the first encrypted content, encrypts the pay content obtained by decryption by a method different from the first protection unit, and stores the encrypted pay content as a second encrypted content,
wherein, when a request for playback of the pay content is made, the second encrypted content is decrypted and provided to the receiving terminal.

2. The content control device according to claim 1, wherein
the first protection unit performs encryption using an encryption key containing a random value and information specific to the user and stores the random value into a storage unit of the receiving terminal, and
the second protection unit performs decryption by acquiring the random value in reference to the storage unit and generating a decryption key based on the acquired random value and the information specific to the user.

3. The content control device according to claim 1, wherein
the first protection unit performs encryption using an encryption key containing information specific to the receiving terminal and information specific to the user, and
the second protection unit performs decryption by generating a decryption key based on the information specific to the receiving terminal and the information specific to the user.

4. The content control device according to claim 1, wherein
the second protection unit encrypts and decrypts the pay content using the information specific to the user as an encryption key and a decryption key.

5. A content control method executed by a content control device connected to a receiving terminal that receives and plays back a content and including an accounting execution unit that executes an accounting process for a user to view a pay content, an accounting completion determination unit that determines whether accounting on the pay content has completed, a first protection unit that encrypts the pay content and stores the encrypted pay content as a first encrypted content, and a second protection unit that decrypts the first encrypted content, encrypts the pay content obtained by decryption by a method different from the first protection unit, and stores the encrypted pay content as a second encrypted content, the method comprising:
an accounting execution step of executing an accounting process for a user to view the pay content by the accounting execution unit after the receiving terminal completes reception of the pay content;
an accounting completion determination step of determining whether accounting on the pay content has completed by the accounting completion determination unit;
a first protection step of, when the receiving terminal has received the pay content, acquiring the pay content from the receiving terminal, encrypting the pay content, and storing the encrypted pay content as a first encrypted content by the first protection unit; and
a second protection step of, when the accounting completion determination step determines that accounting on the pay content has completed, decrypting the first encrypted content, encrypting the pay content obtained by decryption by a method different from the first protection step, and storing the encrypted pay content as a second encrypted content by the second protection unit,
wherein, when a request for playback of the pay content is made, the second encrypted content is decrypted and provided to the receiving terminal.
